(19) United States
(12) Patent Application Publication
(10) Pub. No.: US 2006/0096331 A1
(43) Pub. Date: May 11, 2006

(54) Cleaning device for clothes

(76) Inventor: SooKil (Alex) Kim, Wheeling, IL (US)

Correspondence Address: Douglas H. Pauley;Pauley Petersen & Erickson, Suite 365, 2800 West Higgins Road, Hoffman Estates, IL, 60195, US

(21) Appl. No.: 10/983,215

(22) Filed: Nov. 5, 2004

(51) Int. Cl. B08B 3/12

(52) U.S. Cl. 68/5 C

(57) ABSTRACT

A cleaning device for clothes, to remove smell or odor of any chemical (perc. etc.) permeated into clothes, such as clothes returned from a laundry or a dry cleaning facility. The cleaning device for clothes can sterilize and deodorize clothes housed in a wardrobe, and remove humidity and dust of the clothes by blasting air mixed with ozone and anion into the wardrobe, thereby preventing detrimental substances, such as bacteria, virus, dust or pollen introducible to the clothes. The cleaning device for clothes of this invention includes a blast fan, an ozone generator, an anion generator, a discharge ground net and a heater, and can prevent detrimental substances and can be used semi-permanently once installed inside the wardrobe.

### BACKGROUND OF THE INVENTION

1. Field of the Invention

This invention relates to a cleaning device for clothes, particularly a cleaning device for clothes capable of blowing hot air into a wardrobe in which clothes returned from a laundry are stored and/or other clothes are hung on hangers, to remove odors peculiar to the clothes cleaned by the laundry. The air is mixed with anion and ozone which are good for sterilization, deodorization, and removal of humidity and dust, thereby removing various bacteria, perchloride, ethylene, dust, pollen and odors or even static which may be introduced through the clothes, and maintaining clean air inside the wardrobe.

2. Discussion of Related Art

In general, there has been a method of supplying a sterilizing/deodorizing agent or a dehumidification agent into a wardrobe to maintain clothes well.

A sterilizing and deodorizing agent has been used for preventing the propagation of moths, which are parasitic on vegetable fiber, such as clothes wooden furniture. However, it is difficult for a user to immediately wear the clothes after removal from a wardrobe, because an offensive odor permeates into the clothes.

A dehumidification agent contains a large amount of calcium chloride (CaCl₂) as a main ingredient. Calcium chloride exhibits an excellent hygroscopic property when contacting the air, but it is inconvenient due to frequent replacement requirements.

### SUMMARY OF THE INVENTION

This invention provides a cleaning device for clothes that substantially obviates one or more problems due to limitations and disadvantages of the related art.

One object of this invention is to provide a cleaning device for clothes, which includes an ozone generator, an anion generator, a heater, and a blast fan, and blows hot air mixed with anion and ozone into a wardrobe, to remove offensive odors of any undesirable chemical permeated into clothes, such as clothes returned from a laundry, as well as bacteria, dust and humidity stained on the clothes, thereby maintaining the interior of the wardrobe in a clean condition.

Another object of this invention is to provide a cleaning device for clothes, which is semi-permanently used without offensive odors like a sterilizing/deodorizing agent and without frequent replacement like a dehumidification agent.

To accomplish the above and other objects, according to this invention, a cleaning device for clothes is installed in a wardrobe, and includes a cuboid casing having an air vent formed at one side of the casing. A blast fan is mounted inside the cuboid casing opposite to the air vent. The blast fan can rotate at a high speed for generating airflow. A high voltage generator is mounted adjacent to the blast fan for generating direct current (DC) voltage. An ozone generator is mounted adjacent to the high voltage generator and has a positive (+) discharge ozone generating plate, and a discharge ground net and can generate ozone by electric discharge. An anion generator is arranged parallel with the ozone generator. The anion generator has a negative (−) discharge anion generating plate and a discharge ground net and can generate electrons of negative electricity by electric discharge for negative ionization of the air. The discharge ground net is connected to the high voltage generator. A heater is mounted on the air vent of the casing and is adapted to heat air mixed with ozone and anion generated, respectively, from the ozone and anion generators and blow or direct the heated air into the wardrobe, thereby removing smell or odor of any chemical, such as percchloroethylene (perc.) or the like permeated into clothes, such as those returned from a laundry, as well as bacteria, dust, pollen and odor stained on or even static charge to other clothes inside the wardrobe.

### BRIEF DESCRIPTION OF THE DRAWINGS

The above and other objects, features and advantages of this invention are apparent from the following detailed description of the preferred embodiments of this invention in view of the accompanying drawings, wherein:

FIG. 1 is an exploded perspective diagrammatic view of a cleaning device according to one embodiment of this invention;

FIG. 2 is a sectional diagrammatic view taken along a longitudinal axis, according to one embodiment of this invention;

FIG. 3 is a perspective schematic view showing an installation of a cleaning device according to this invention.

### DESCRIPTION OF PREFERRED EMBODIMENTS

The following preferred embodiments of this invention are intended to be examples of many embodiments, and are illustrated in the drawings.

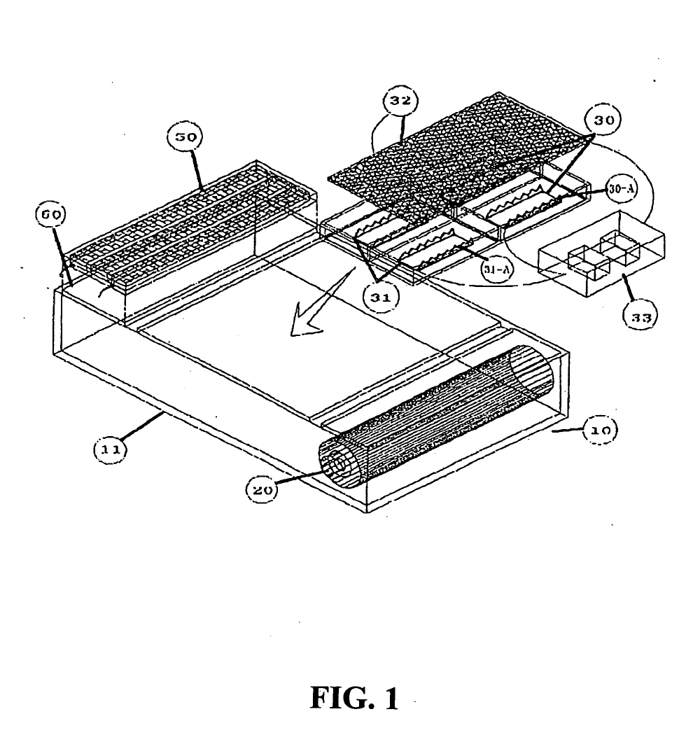

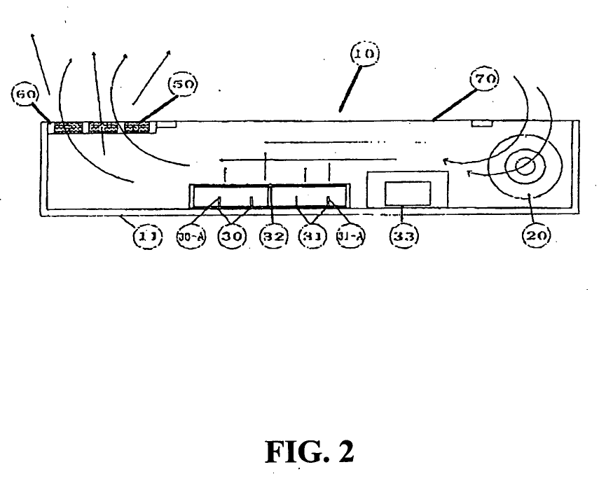

A shown in FIGS. 1 and 2, a cleaning device 10 for clothes according to this invention comprises a cuboid casing 11, a blast fan 20, an ozone generator 30 and an anion generator 31 which are mounted inside the casing 11, an air vent 60 projecting on a side of the upper portion of the casing 11, and a heater 50 mounted on an outlet of the air vent 60.

The blast fan 20 rotates at a high speed to generate airflow and blows the air mixed with ozone and anion, which are respectively generated from the ozone generator 30 and the anion generator 31, into a wardrobe 80. At this time, the blast fan 20 blows hot air heated by the heater 50 mounted on the air vent 60 to remove various bacteria, dust, pollen, odors and humidity stained on clothes and any static charge, as well as odor of any undesirable chemical (perc. etc.) permeated into clothes returned from a laundry, thereby maintaining the clothes within the wardrobe in a sanitary condition.

The anion generator 31 includes a negative (−) discharge anion generating plate 31-A and a discharge ground net 32, and generates electrons of negative electricity by electric discharge for negative ionization of the air.

More specifically, one side of the high voltage generator 33 generates −4.7 kv (kilovolt) DC voltage for application to the negative (−) discharge anion generating plate 31-A, and the other side of the high voltage generator 33 is connected to the discharge ground net 32. Then, electrons of negative electricity are emitted by electric discharge at a high speed, and meet with oxygen in the air, so that the air is negative-ionized.

In this specification and in the claims, an anion refers to an ion negatively charged when an electron with negative electric charge is coupled to oxygen in the air.

The ozone generator 30 includes a positive (+) discharge ozone generating plate 30-A and the discharge ground net 32, and generates ozone by electric discharge.

More specifically, one side of the high voltage generator 33 generates +5.7 kv (kilovolt) DC voltage for application to the positive (+) discharge ozone generating plate 30-A, and the other side of the high voltage generator 33 is connected to the discharge ground net 32. Then, ozone is emitted by electric discharge.

The air passed through the heater 50 is converted into hot airflow of 70 degrees centigrade, and sent into the wardrobe to dry the clothes within the wardrobe and remove odor of any chemical (perc. etc.) permeated into the clothes.

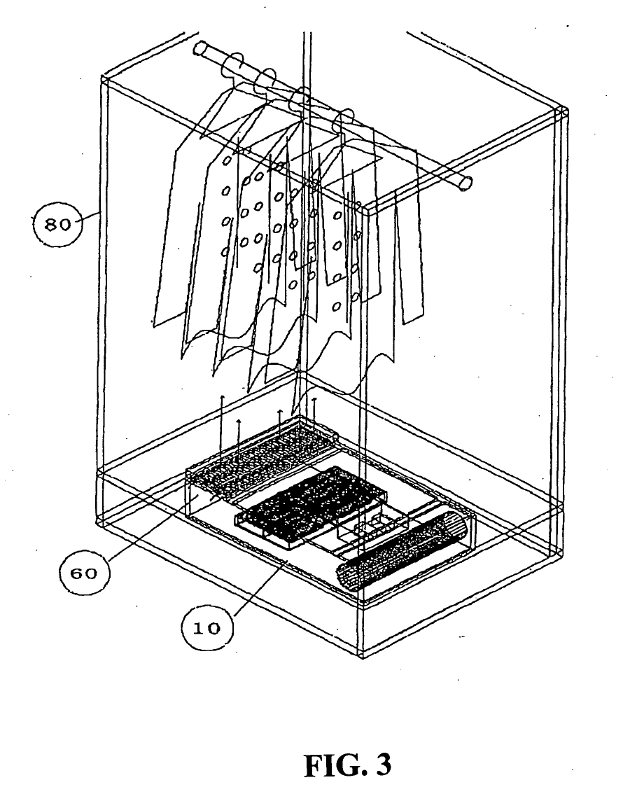

Furthermore, as shown in FIG. 3, the cleaning device according to this invention can be installed in a lower space 81 inside the wardrobe 80, so that an electric appliance and a piece of furniture are combined with each other, and can be used semi-permanently without frequent replacement.

As described above, the cleaning device for clothes according to this invention can remove the smell or odor of any undesirable chemical (perc. etc.) permeated into the clothes, such as those returned from the laundry or a cleaning facility, as well as bacteria, dust and odor stained on other clothes hanging or otherwise stored in the wardrobe, thereby maintaining the wardrobe in a clean condition.

This invention is described with reference to the particular illustrative embodiments, and this invention is not to be restricted by the described embodiments. It is to be appreciated that those skilled in the art can change or modify the embodiments described in this specification and in the claims without departing from the scope and spirit of this invention.

What is claimed is:

1. A cleaning device for clothes, wherein the cleaning device is installed in a wardrobe, the cleaning device comprising:
a casing having an air vent formed at one side of the casing;
a fan mounted inside the casing opposite to the air vent, the fan rotatable for generating an airflow;
a high voltage generator mounted adjacent to the fan for generating a direct current (DC) voltage;
an ozone generator mounted adjacent to the high voltage generator, the ozone generator having a positive discharge ozone generating plate and a discharge ground net and adapted to generate ozone by electric discharge;
an anion generator arranged parallel with the ozone generator, the anion generator having a negative discharge anion generating plate and the discharge ground net and adapted to generate electrons of negative electricity by electric discharge for negative ionization of the air, the discharge ground net connected to the high voltage generator; and
a heater mounted on the air vent of the casing and adapted to heat air mixed with ozone and anion generated respectively from the ozone generator and the anion generator and to pass heated air into the wardrobe to remove at least one of an odor of a chemical permeated into clothes, a bacteria, a dust, a pollen, a static charge and an odor stained on the clothes inside the wardrobe.

2. The cleaning device according to claim 1, wherein the casing has a cuboid shape.

3. The cleaning device according to claim 1, wherein the fan is a blast fan.

4. The cleaning device according to claim 1, wherein the fan is rotatable at a high speed.

5. The cleaning device according to claim 1, wherein the odor is associated with the clothes as returned from a laundry facility.

6. The cleaning device according to claim 1, wherein the odor is associated with the clothes as returned from a dry cleaning facility.

7. The cleaning device according to claim 1, wherein the chemical is a perc.

8. A cleaning device for clothes, wherein the cleaning device is installed in a wardrobe, the cleaning device comprising:
a cuboid casing having an air vent formed at one side of the cuboid casing;
a blast fan mounted inside the casing opposite to the air vent, the blast fan rotatable at a high speed for generating an airflow;
a high voltage generator mounted adjacent to the blast fan for generating a direct current (DC) voltage;
an ozone generator mounted adjacent to the high voltage generator, the ozone generator having a positive (+) discharge ozone generating plate and a discharge ground net and adapted to generate ozone by electric discharge;
an anion generator arranged parallel with the ozone generator, the anion generator having a negative (−) discharge anion generating plate and the discharge ground net and adapted to generate electrons of negative electricity by electric discharge for negative ionization of the air, the discharge ground net connected to the high voltage generator; and
a heater mounted on the air vent of the casing and adapted to heat air mixed with ozone and anion generated respectively from the ozone generator and the anion generator and to pass heated air into the wardrobe to remove at least one of an odor of a chemical permeated into clothes, a bacteria, a dust, a pollen, a static charge and an odor stained on the clothes inside the wardrobe.
